(19) United States
(12) Patent Application Publication
(10) Pub. No.: US 2025/0212232 A1
(43) Pub. Date: Jun. 26, 2025

(54) USER EQUIPMENT AND METHOD OF SIDELINK RESOURCE SELECTION IN SHARED SPECTRUM

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/077,586

(22) Filed: Mar. 12, 2025

Related U.S. Application Data
(63) Continuation of application No. PCT/CN2022/130062, filed on Nov. 4, 2022.

(51) Int. Cl. H04W 72/25

(52) U.S. Cl. CPC H04W 72/25

(57) ABSTRACT

A method of sidelink resource selection in a shared spectrum by a user equipment (UE) is disclosed. The method includes that: the UE performs a guard band (GB) resource selection based on an allocated resource in an adjacent channel/resource block (RB) set and/or a sidelink resource reservation information. A utilization/selection of resources in GBs for sidelink transmission can be allowed for the UE transmitting sidelink signals/channels across multiple and consecutive shared channels/RB sets.

### CROSS-REFERENCE TO RELATED APPLICATION

This is a continuation application of International Patent Application No. PCT/CN2022/130062, filed on Nov. 4, 2022, entitled “USER EQUIPMENT AND METHOD OF SIDELINK RESOURCE SELECTION IN SHARED SPECTRUM”, the disclosure of which is hereby incorporated by reference in its entirety.

### BACKGROUND OF DISCLOSURE

In the advancement of radio wireless transmission and reception directly between two devices, which is often known as device-to-device (D2D) communication, it was first developed by 3rd generation partnership project (3GPP) and introduced in release 12 (officially specified as sidelink communication) for public safety emergency usage such as mission critical communication to support mainly low data rate and voice type of connection. In 3GPP releases 14, 15, and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in release 17 in the area of power saving and transceiver link reliability. For release 18, 3GPP is looking to evolve the wireless technology and expand its operation into unlicensed frequency spectrum for bigger bandwidth, faster data rate, and easier market adoption of D2D communication using sidelink without requiring mobile cellular operators to configure and allocate a part of their expansive mobile radio spectrum for data services that do not go throughput their mobile networks.

Therefore, there is a need for a user equipment (UE) and a method of sidelink resource selection in a shared spectrum, which can solve issues in the prior art, avoid transmission collision, ensure interference and collision free operation, provide a good communication performance, and/or provide high reliability.

### SUMMARY

The present disclosure relates to the field of communication systems, and more particularly, to a user equipment (UE) and a method of sidelink resource selection in a shared spectrum, which can provide a good communication performance and/or provide high reliability.

In a first aspect of the present disclosure, a method of sidelink resource selection in a shared spectrum by a user equipment (UE) includes performing, by the UE, a guard band (GB) resource selection based on an allocated resource in an adjacent channel/resource block (RB) set and/or a sidelink resource reservation information.

In a second aspect of the present disclosure, a user equipment (UE) includes a memory, a transceiver, and a processor coupled to the memory and the transceiver. The processor is configured to cause the UE to perform a method of sidelink resource selection in a shared spectrum. The method includes: performing a guard band (GB) resource selection based on an allocated resource in an adjacent channel/resource block (RB) set and/or a sidelink resource reservation information.

In a third aspect of the present disclosure, a non-transitory machine-readable storage medium has stored thereon instructions that, when executed by a computer, cause the computer to perform a method of sidelink resource selection in a shared spectrum. The method includes: performing a guard band (GB) resource selection based on an allocated resource in an adjacent channel/resource block (RB) set and/or a sidelink resource reservation information.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method of sidelink resource selection in a shared spectrum by a UE according to an embodiment of the present disclosure.

FIG. 5 is a schematic diagram illustrating an exemplary proposed resource selection method for interlaced guard band PRBs based on a lower RB_set.

FIG. 6 is a schematic diagram illustrating an exemplary proposed resource selection method for interlaced and non-interlaced guard band PRBs based on a higher RB_set according to an embodiment of the present disclosure.

FIG. 7 is a schematic diagram illustrating exemplary proposed resource selection methods for interlaced and non-interlaced guard band PRBs based on a lower RB_set and reservation status according to an embodiment of the present disclosure.

FIG. 8 is a schematic diagram illustrating exemplary proposed resource selection methods for interlaced and non-interlaced guard band PRBs based on a higher RB_set and reservation status according to an embodiment of the present disclosure.

FIG. 9 is a block diagram of a UE for wireless communication according to an embodiment of the present disclosure.

FIG. 10 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Shared/Unlicensed Spectrum

Traditionally, unlicensed (also referred as license-exempted) radio spectrum in 2.4 GHz and 5 GHz bands are commonly used by Wi-Fi and Bluetooth wireless technologies for short range communication (such as from just a few meters to few tens of meters). It is often claimed that more traffic is carried over unlicensed spectrum bands than any other radio bands since the frequency spectrum is free/at no-cost to use by anyone as long as communication devices are compliant to certain local technical regulations. Besides, Wi-Fi, Bluetooth, and other radio access technologies (RATs) such as licensed-assisted access (LAA) based on 4G-long term evolution (LTE) and new radio unlicensed (NR-U) based on 5G-new radio (NR) mobile systems from 3GPP also operate in the same unlicensed bands. In order for devices of different RATs (Wi-Fi, Bluetooth, LAA, NR-U and possibly others) to operate simultaneously and coexistence fairly in the same geographical area without causing significant interference and interruption to each other's transmission, a clear channel access (CCA) protocol such as listen-before-talk (LBT) adopted in LAA and NR-U and carrier sense multiple access/collision avoidance (CSMA/CA) used in Wi-Fi and Bluetooth are employed before any wireless transmission is carried out to ensure that a wireless radio does not transmit while another is already transmitting on the same channel.

For the sidelink wireless technology to also operate and coexistence with existing RATs already operating in the unlicensed bands, LBT based schemes can be employed to make certain there is no on-going activity on the radio channel before attempting to access the channel for transmission. For example, when a type 1 LBT is successfully performed by a sidelink user equipment (UE), the UE has the right to access and occupy the unlicensed channel for a duration of a channel occupancy time (COT). During an acquired COT, however, a device of another RAT could still gain access to the channel if no wireless transmission is performed by the COT initiation sidelink UE or a COT responding sidelink UE for an idle period longer than 25 us. Hence, potentially losing the access to the channel until another successful LBT is performed. A potential solution to this issue of losing the access to the channel could be a back-to-back (B2B) transmission.

### Back-to-Back Transmission

The main purpose of B2B transmission (which can be also referred as “burst transmission” or “multi-consecutive slot transmission (MCSt)”) is intended for a sidelink (SL) communicating UE to occupy an unlicensed channel continuously for longer duration of time (i.e., more than one time slot) without a risk of losing the access to the channel to wireless transmission (Tx) devices of other radio access technologies (RATs). This can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or has a short latency requirement (small packet delay budget, PDB). When the unlicensed wireless channel is busy/congested (e.g., with many devices trying to access the channel simultaneously for transmission), it can be difficult and take up a long time to gain access to the channel due to the random backoff timer and priority class category in the LBT procedure. Therefore, when a UE finally has a chance/opportunity to gain access to the wireless channel for a channel occupancy time (COT) length which may last for a few milliseconds (e.g., 4, 8, or 10 ms), the intention is to retain the channel access for as long as possible (e.g., all or most of the COT length) to send as much data as possible by continuously transmitting in the unlicensed channel such that wireless devices of other RATs would not have a chance to access the channel.

### Guard Band Radio Resources in Shared/Unlicensed Spectrum

In radio communication, a guard band (GB) is typically an unused part of the radio spectrum between two frequency bands or channels, for the sole purpose of protecting radio transmissions/reducing or minimizing interference to the adjacent frequency channels due to spectral emission leakage from imperfect radio components. GBs are commonly used/imposed by regional spectrum regulators for radio communication and devices typically can only operate within the frequency range of designated channels but not in the GB which is in between the channels. For the unlicensed spectrum in 5 GHz and 6 GHz bands, the total frequency bandwidth in each of these bands is sub-divided into channels of frequency blocks (e.g., 20 MHz per channel), such that a radio transmission of a smaller packet only needs to occupy one of the channels but not the entire frequency band. A small GB can be allocated in between two adjacent channels for interference protection. For transmitting a larger size packet, more channels can be used by the device. In the 5th generation (5G) new radio (NR) mobile communication, these channels of 20 MHz frequency blocks are called resource block sets (RB_sets). For example, in the 5 GHz unlicensed frequency band, which has a total available bandwidth of 80 MHz, is sub-divided into 4 RB_sets and each with 20 MHz bandwidth in a NR unlicensed (NR-U) system. A small GB containing some number of physical resource blocks (PRBs) is allocated in between two adjacent RB_sets, and there are 3 GBs in total as such. To reduce or minimize interference and be compatible to the NR-U system sharing the same unlicensed band, SL-U operation should follow the same RB_set definition and GB settings.

### Interlaced Resource Pattern for SL-U

Regulation for radio frequency emission in some regions of the world requires a certain amount of occupied channel bandwidth (OCB) (e.g., 80%) and a certain limitation for the power spectral density (PSD) to be fulfilled most of the time in the unlicensed spectrum (with some special exemptions), as a measure to ensure fair coexistence among different radio access technologies sharing a common unlicensed spectrum. In order to satisfy these regulation requirements, the NR-U system adopted interlaced patterns for mapping data baseband symbols across multiple physical resource blocks (PRBs) in such a way that the modulated radio signal and the energy is spread over e.g., 80% of the channel bandwidth to lower the PSD. To simplify the design, the same principle of using interlace resource patterns could be also adopted in SL-U to fulfill the regional requirements.

### Mode 2 Resource Selection in Sidelink

In the existing design of resource allocation mechanism for SL communication, a mode 2 resource selection method relies on the SL transmission UE to perform autonomous selection of resources from a SL resource pool for its own transmission of data messages. In this exemplary method, the selection of transmission resources is not random but based on a sensing and reservation strategy to avoid collision with other SL transmission UEs operating in the same resource pool. In this exemplary resource selection strategy, a transmission UE senses the channel within a sensing window (which is different from the LBT channel sensing) to detect and decode SL resource reservation information from other transmission UEs. Based on the resource reservation information, the UE excludes some of the reserved resources from selection to avoid transmission collision. Likewise, the UE also sends out/broadcasts its own resource reservation information in the resource pool when it transmits data and control messages, so that other UEs may avoid selecting the same resource. In the existing resource selection and reservation signaling design, the time gap between two consecutive resources can be up to 31 slots apart. With this type of resource selection method, it is not ideal for MCSt as there is no guarantee that resources may be selected contiguously in time.

For the present exemplary proposed simple and effective resource selection method for sidelink communication in an unlicensed spectrum, one of the main objectives is to maximally utilize the guard band frequency resources between two adjacent RB_sets whenever it is feasible without causing interference to the two adjacent RB_sets and transmission collision with other SL UEs in the system. In achieving this one main objective, the working principles of proposed methods are based on the allocation of selected resources in the adjacent RB_sets and reservation status of other UEs in the adjacent RB_sets to ensure interference and collision free operation.

Other benefits from adopting the exemplary proposed resource selection method for MCSt may include:

Maximally increase the data rate and reliability performance of sidelink transmission from taking advantage of otherwise unused resource blocks within the frequency guard band.

Eliminate the restriction/limitation adopted in NR-U of using only a frequency resource index within the guard band when the same index is also used in the two adjacent RB_sets.

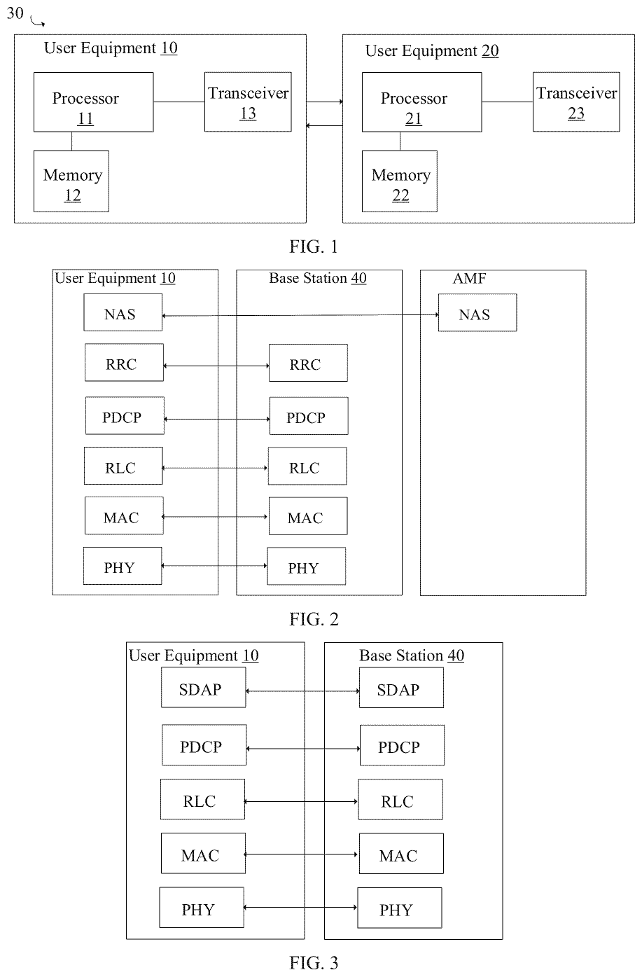

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 2 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to perform a guard band (GB) resource selection based on an allocated resource in an adjacent channel/resource block (RB) set and/or a sidelink resource a reservation information. This can solve issues in the prior art, avoid transmission collision, ensure interference and collision free operation, provide a good communication performance, and/or provide high reliability.

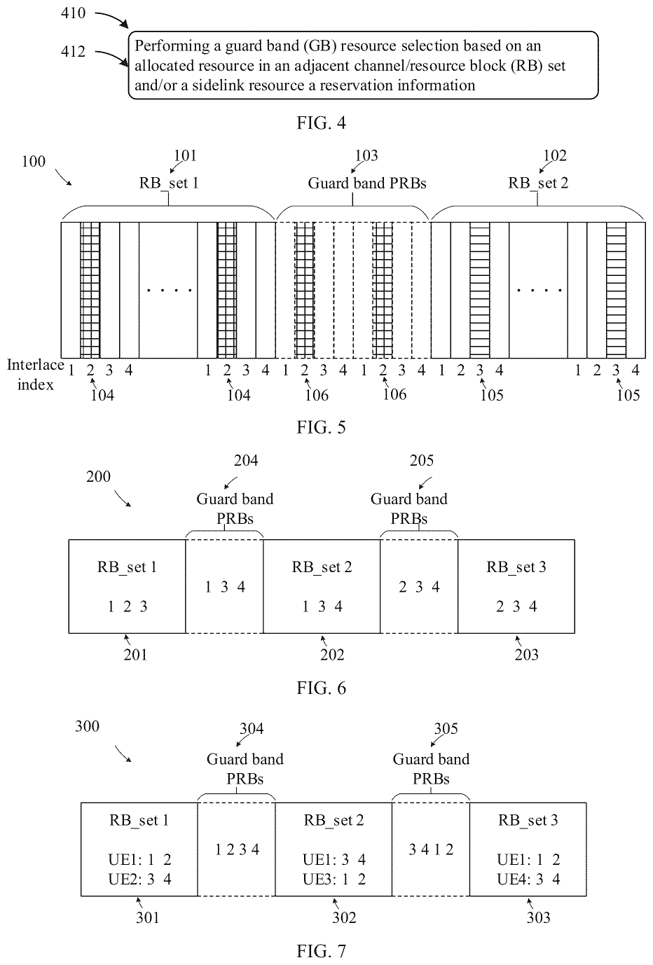

FIG. 4 illustrates a method 410 of sidelink resource selection in a shared spectrum by a UE by a UE according to an embodiment of the present disclosure. In some embodiments, the method 410 includes: a block 412, performing a guard band (GB) resource selection based on an allocated resource in an adjacent channel/resource block (RB) set and/or a sidelink resource a reservation information. This can solve issues in the prior art, avoid transmission collision, ensure interference and collision free operation, provide a good communication performance, and/or provide high reliability.

In some embodiments, a utilization/selection of resources in GBs for sidelink transmission is allowed for the UE transmitting sidelink signals/channels across multiple and consecutive shared channels/RB sets. In some embodiments, the UE dose not utilize GB resources when the UE intends to transmit using only one shared channel/RB set. In some embodiments, a utilization/selection of resources in GBs for sidelink transmission by the UE is based on UE's selected and/or reserved resource frequency position/location in an RB set adjacent to a GB. In some embodiments, a selection of a GB resource between two adjacent RB sets is based on a frequency position/location of a selected resource in a lower adjacent RB set or a higher adjacent RB set.

In some embodiments, a first selection of a GB resource between two adjacent RB sets is based on a frequency position/location of a selected resource in a lower adjacent RB set or a higher adjacent RB set, and a second selection of a GB resource between two adjacent RB sets is based on the sidelink resource reservation information. In some embodiments, the selection of the GB resource based on the lower adjacent RB set or the higher adjacent RB set is pre-defined or configured to the UE. In some embodiments, in the GB resource selection based on the sidelink resource reservation information, a use of resource sensing results is used as a part of a mode 2 resource selection procedure to determine which GB resource is utilized by UEs that intend to transmit in multiple shared channels/RB sets. In some embodiments, when a certain resource within a shared channel/RB set is reserved by another UE but the another UE intends to transmit on a single shared channel/RB set, a resource in the GB that corresponds to or has the same resource index as the certain resource is selected for use by the UE that intends to transmit using multiple shared channels/RB sets. In the above embodiments, the term “configured” can refer to “pre-configured” and “network configured”.

In the present disclosure of exemplary inventive resource selection methods within a frequency guard band (GB) of an unlicensed spectrum for sidelink (SL) communication, the methods provide efficient ways of utilizing GB resources that are otherwise unused for radio communication when the utilization may not cause interference to the adjacent channels. Furthermore, the proposed exemplary selection methods also take into account of resource reservation status/information of other devices/user equipment (UE) in the adjacent channels such that the transmission using the GB resources may not cause collision with others.

As described previously in the above embodiments, there are multiple channels/resource block sets (RB_sets) and guard bands allocated in between adjacent RB_sets in the unlicensed spectrum bands. For the 5th generation (5G) new radio (NR) system operating in an unlicensed band (NR-U), it is allowed for the scheduling base station (gNB) to utilize frequency resources within the GBs for downlink (DL) transmissions and assign frequency resources within the GBs to a user equipment (UE) for uplink (UL) transmissions, as long as the transmission spans across at least two adjacent RB_sets/unlicensed channels such that the transmission does not cause interference to other devices in the unlicensed band. And since the gNB controls and schedules all DL and UL transmissions in the system, it can ensure no transmission (TX) collision will occur. On the other hand, sidelink (SL) operation in an unlicensed band (SL-U) may not involve a base station (gNB or eNB) to always configure and/or schedule the exact resources for SL transmissions. And this is particularly true for sidelink resource allocation Mode 2 (e.g., for use in radio resource control (RRC) IDLE, INACTIVE state, out-of-network coverage operation, or without Uu link capability), where a sidelink TX UE needs to select one or more resources autonomously from a transmission resource pool while trying to avoid selecting same or overlapping resources to other UEs to minimize TX collisions. Therefore, the selection of frequency resources within the GBs of an unlicensed spectrum when a UE needs to delivery large size data packets by transmitting SL signals over multiple RB_sets/unlicensed channels become a challenge and it needs to be resolved.

In particular, the allocation of resources is performed in a distributed manner by each UE without coordination in sidelink mode 2, where the data TX UE selects time and frequency resources on its own and transmission collision is avoided based on a SL sensing and reservation mechanism. As such, some SL-U UEs may only need to use one RB_set to transmit small size data packets and not able to utilize the GB resources while others may try to transmit large size data packets over multiple RB_sets and utilize the GB resources in between the RB_sets. However, due to the distributed resource selection approach adopted in SL transmission, it is not possible for a TX UE to know in advance whether the GB resources will be utilized by others since the UE does not perform SL sensing and a listen-before-talk (LBT) channel access procedure for the GB spectrum. Hence, a common resource selection mechanism for the GB resources is needed for all UEs operating in the unlicensed spectrum in order to avoid any resource conflict.

In the following, detailed description of the exemplary proposed simple and effective methods of determining and selecting GB spectrum resources for SL transmission in an unlicensed spectrum is provided. It should be noted that these methods can be jointly operated by a UE to select GB resources.

### Exemplary Method 1: GB Resource Selection Based on Allocated Resource in an Adjacent Channel/RB_Set

In order to ensure there is no overlapping/conflict in the selection of resources in the GBs and causing transmission collisions among different SL TX UEs, the exemplary proposed first resource selection method employs two rules/principles and at least one of them can be adopted by UEs operating in the unlicensed spectrum bands.

1) The utilization/selection of resources in the GBs for SL transmission is allowed for UEs transmitting SL signals/channels across multiple and consecutive shared channels/RB_sets.

2) The utilization/selection of resources in the GBs for SL transmission by a UE is based on UE's selected and/or reserved resource frequency position/location in the RB_set adjacent to the GB.

For the rule/principle 1), besides ensuring that the GB resource selected for transmission would not overlap with other UEs, it also avoids radio emission interference to the adjacent channels/RB_sets by not utilizing the GB resources when the UE intends to transmit using only one shared channel/RB_set.

For the rule/principle 2), the dependency of UE's selected and/or reserved resource frequency position/location in the RB_set adjacent to the GB could be based on the lower RB_set or higher RB_set. That is, the selection of a GB resource between two adjacent RB_sets could be based on the frequency location of a selected resource in either the lower adjacent RB_set or the higher adjacent RB_set. And whether the selection of a GB resource is based on the lower or higher adjacent RB_set could be pre-defined or (pre-)configured to a UE. For example, for a TX UE that has selected resource index 5 in both two adjacent shared channels/RB_sets, then the TX UE can utilize GB resource(s) in between the two adjacent shared channels/RB_sets that corresponds the same resource index 5 for its SL transmission, regardless if the lower or higher adjacent shared channel/RB_set is pre-defined or (pre-)configured for the utilization.

It should be noted that:

1. A frequency resource described in the present disclosure could be a SL sub-channel index containing multiple resource blocks (RBs) or a SL frequency interlace resource index which can spans across multiple RBs. Depending on regional regulation on the OCB and PSD requirements, the sub-channel index or interlace index may be used.

2. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, a LTE protocol, NR protocol and relevant protocol applied in the future communication system, which is not limited in the present disclosure.

FIG. 5 illustrates an exemplary proposed resource selection method for interlaced guard band PRBs based on a lower RB_set. FIG. 5 illustrates that, in some embodiments, the exemplary proposed resource selection method 1 for interlaced guard band PRBs based on the lower RB_set is exemplary illustrated. In diagram 100, two shared channels/RB_sets 101, 102 and a GB with multiple PRBs 103 in an unlicensed spectrum band are illustrated for simplicity. It is further assumed that by pre-definition or (pre-)configuration, the selection of GB resources could be based on the lower shared channel/RB_set when a UE is selecting or selects resources for SL transmission across multiple shared channels/RB_sets. In the illustrated example, the UE has selected interlace resource index 2 (104s) in RB_set 1 and interlace resource index 3 (105s) in RB_set 2 for SL transmission. Since the pre-definition/(pre-)configuration is to select GB resources according to the lower adjacent RB_set, the UE is then allowed to select/utilize interlace resource index 2 (106s) in the GB PRBs 103 for the SL transmission.

FIG. 6 illustrates an exemplary proposed resource selection method for interlaced and non-interlaced guard band PRBs based on a higher RB_set according to an embodiment of the present disclosure. In some embodiments, in reference to diagram 200 of FIG. 6, another exemplary illustration is provided for the case when the pre-definition or (pre-)configuration is provided to select GB resources according to the higher adjacent shared channel/RB_set when a UE is selecting or selects resources for SL transmission across multiple shared channels/RB_sets. In this illustration, three shared channels/RB_sets 201, 202, 203 are illustrated with GB PRBs 204 located in between RB_set 1 201 and RB_set 2 202, and GB PRBs 205 located in between RB_set 2 202 and RB_set 3 203. Since the pre-definition/(pre-)configuration is to select GB resources according to the higher adjacent RB_set, the UE is then allowed to select/utilize interlace resource index 1, 3, and 4 in GB PRBs 204 according to the selected interlace resource indexes in RB_set 2 202, and interlace resource index 2, 3, and 4 in GB PRBs 205 according to the selected interlace resource indexes in RB_set 3 203 for the SL transmission.

### Exemplary Method 2: GB Resource Selection Based on Sidelink Resource Reservation Information (Sidelink Sensing and Reservation Status)

To further enhance the utilization of GB resources, for UEs that only perform SL transmission in a single shared channel/RB_set, as previously described they should not select and utilize GB resources located in between two adjacent shared channels/RB_sets. As such, for resource indexes that are selected by a UE only intends to perform single shared channel/RB_set transmission, the corresponding resource indexes in the GB PRBs may not be utilized at all, and hence, a potential wastage.

In order to improve the utilization of these otherwise unused GB resources due to single shared channel/RB_set transmissions, the exemplary proposed resource selection method 2 is to make use of resource sensing results obtained from the normal SL sensing process as part of the Mode 2 resource (re)selection procedure to determine which GB resource(s) can still be utilized by a UE that intend to transmit in multiple shared channels/RB_sets. That is, when a certain resource (index) within a shared channel/RB_set is reserved by another UE but the another UE intends to transmit only on a single shared channel/RB_set (based on the resource reservation information carried in sidelink control information), the resource in the GB that corresponds to or has the same resource index as the certain resource in the RB_set would become available or can be selected for use by a TX UE that intends to transmit using multiple shared channels/RB_sets.

FIG. 7 illustrates exemplary proposed resource selection methods for interlaced and non-interlaced guard band PRBs based on a lower RB_set and reservation status according to an embodiment of the present disclosure. In reference to the diagram 300 in FIG. 7, an exemplary illustration of the combined resource selection method 1 and method 2 for utilizing guard band PRBs based on the lower RB_set and reservation status is illustrated. In this example, three shared channels/RB_sets 301, 302, 303 are illustrated with GB PRBs 304 located in between RB_set 1 301 and RB_set 2 302, and GB PRBs 305 located in between RB_set 2 302 and RB_set 3 303. Moreover, it is assumed the pre-definition or (pre-)configuration to select GB resources according to the lower adjacent shared channel/RB_set is provided. According to the illustration, UE1 has selected resource/interlace index 1 and 2 in RB_set 1 301, resource/interlace index 3 and 4 in RB_set 2 302, and resource/interlace index 1 and 2 in RB_set 3 303 for multi consecutive shared channels/RB_sets transmission. According to the exemplary proposed GB resource selection method 1, the UE1 can at least utilize GB resource/interlace index 1 and 2 in the GB PRBs 304 between RB_set 1 301 and RB_set 2 302, and GB resource/interlace index 3 and 4 in the GB PRBs 305 between RB_set 2 302 and RB_set 3 303. In addition, based on SL resource sensing performed in RB_set 1, RB_set 2 and RB_set 3 as part of Mode 2 resource selection procedure, the UE1 detects:
resource/interlace index 3 and 4 in RB_set 1 301 are reserved by UE2 for single shared channel/RB_set transmission,
resource/interlace index 1 and 2 in RB_set 2 302 are reserved by UE3 for single shared channel/RB_set transmission, and
resource/interlace index 3 and 4 in RB_set 3 303 are reserved by UE4 also for single shared channel/RB_set transmission.

As such, if following the pre-definition/(pre-)configuration that GB resource utilization could be done according to the lower adjacent RB_set, UE1 could further utilize GB resource/interlace index 3 and 4 in the GB PRBs 304 since they won't be used by UE2, and also utilize GB resource/interlace index 1 and 2 in the GB PRBs 305 since they won't be used by UE3.

FIG. 8 illustrates exemplary proposed resource selection methods for interlaced and non-interlaced guard band PRBs based on a higher RB_set and reservation status according to an embodiment of the present disclosure. In reference to the diagram 400 in FIG. 8, an exemplary illustration of the combined resource selection method 1 and method 2 for utilizing guard band PRBs based on the higher RB_set and reservation status is illustrated. In this example, three shared channels/RB_sets 401, 402, 403 are illustrated with GB PRBs 404 located in between RB_set 1 401 and RB_set 2 402, and GB PRBs 405 located in between RB_set 2 402 and RB_set 3 403. Moreover, it is assumed the pre-definition or (pre-)configuration to select GB resources according to the higher adjacent shared channel/RB_set is provided. According to the illustration, UE1 has selected resource/interlace index 1 and 2 in RB_set 1 401, resource/interlace index 3 and 4 in RB_set 2 402, and resource/interlace index 1 and 2 in RB_set 3 403 for multi consecutive shared channels/RB_sets transmission. According to the exemplary proposed GB resource selection method 1, the UE1 can at least utilize GB resource/interlace index 3 and 4 in the GB PRBs 404 between RB_set 1 401 and RB_set 2 402, and GB resource/interlace index 1 and 2 in the GB PRBs 405 between RB_set 2 402 and RB_set 3 403. In addition, based on SL resource sensing performed in RB_set 1, RB_set 2 and RB_set 3 as part of Mode 2 resource selection procedure, the UE1 detects:
resource/interlace index 3 and 4 in RB_set 1 401 are reserved by UE2 for single shared channel/RB_set transmission,
resource/interlace index 1 and 2 in RB_set 2 402 are reserved by UE3 for single shared channel/RB_set transmission, and
resource/interlace index 3 and 4 in RB_set 3 403 are reserved by UE4 also for single shared channel/RB_set transmission.

As such, if following the pre-definition/(pre-)configuration that GB resource utilization could be done according to the higher adjacent RB_set, UE1 could further utilize GB resource/interlace index 1 and 2 in the GB PRBs 404 since they won't be used by UE3, and also utilize GB resource/interlace index 3 and 4 in the GB PRBs 405 since they won't be used by UE4.

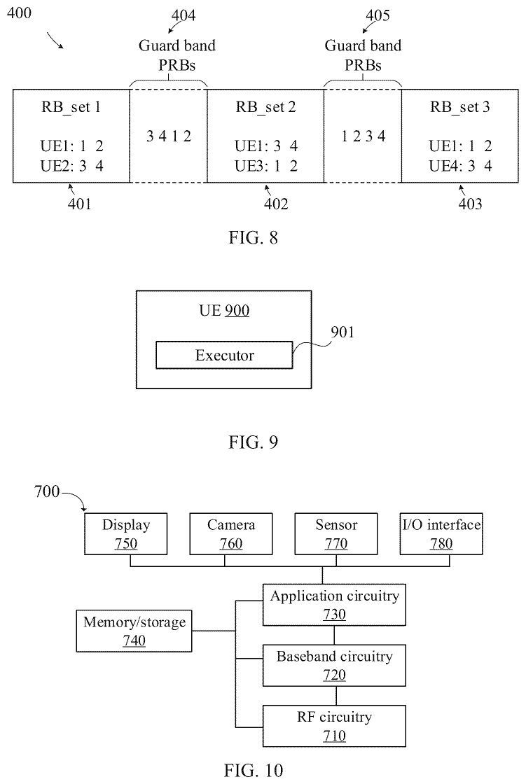

FIG. 9 illustrates a UE 900 for wireless communication according to an embodiment of the present disclosure. The UE 900 includes an executor 901 configured to perform a guard band (GB) resource selection based on an allocated resource in an adjacent channel/resource block (RB) set and/or a sidelink resource a reservation information. The executor 901 is configured to perform the above method in the above embodiments. This can solve issues in the prior art, avoid transmission collision, ensure that an access to an unlicensed wireless channel is retained for its own transmissions, provide a good communication performance, and/or provide high reliability.

Commercial interests for some embodiments are as follows. 1. Solving issues in the prior art. 2. Avoiding transmission collision. 3. Ensuring interference and collision free operation. 4. Providing good communication performance. 5. Providing high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

FIG. 10 is a block diagram of an example system 700 for wireless communication according to an embodiment of the present disclosure. Embodiments described herein may be implemented into the system using any suitably configured hardware and/or software. FIG. 10 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of sidelink resource selection in a shared spectrum by a user equipment (UE), comprising:
performing, by the UE, a guard band (GB) resource selection based on an allocated resource in an adjacent channel/resource block (RB) set and/or a sidelink resource reservation information.

2. The method of claim 1, wherein a utilization/selection of resources in GBs for sidelink transmission is allowed for the UE transmitting sidelink signals/channels across multiple and consecutive shared channels/RB sets.

3. The method of claim 2, wherein the UE dose not utilize GB resources when the UE intends to transmit using only one shared channel/RB set.

4. The method of claim 1, wherein a utilization/selection of resources in GBs for sidelink transmission by the UE is based on UE's selected and/or reserved resource frequency position/location in an RB set adjacent to a GB.

5. The method of claim 4, wherein a selection of a GB resource between two adjacent RB sets is based on a frequency position/location of a selected resource in a lower adjacent RB set or a higher adjacent RB set.

6. The method of claim 4, wherein a first selection of a GB resource between two adjacent RB sets is based on a frequency position/location of a selected resource in a lower adjacent RB set or a higher adjacent RB set, and a second selection of a GB resource between two adjacent RB sets is based on the sidelink resource reservation information.

7. The method of claim 5, wherein the selection of the GB resource based on the lower adjacent RB set or the higher adjacent RB set is pre-defined or configured to the UE.

8. The method of claim 1, wherein in the GB resource selection based on the sidelink resource reservation information, a use of resource sensing results is used as a part of a mode 2 resource selection procedure to determine which GB resource is utilized by UEs that intend to transmit in multiple shared channels/RB sets.

9. The method of claim 8, wherein when a certain resource within a shared channel/RB set is reserved by another UE but the another UE intends to transmit on a single shared channel/RB set, a resource in the GB that corresponds to or has the same resource index as the certain resource is selected for use by the UE that intends to transmit using multiple shared channels/RB sets.

10. A user equipment (UE), comprising:
a memory;
a transceiver; and
a processor coupled to the memory and the transceiver;
wherein the processor is configured to cause the UE to perform a method of sidelink resource selection in a shared spectrum, the method comprising:
performing a guard band (GB) resource selection based on an allocated resource in an adjacent channel/resource block (RB) set and/or a sidelink resource reservation information.

11. The UE of claim 10, wherein a utilization/selection of resources in GBs for sidelink transmission is allowed for the UE transmitting sidelink signals/channels across multiple and consecutive shared channels/RB sets.

12. The UE of claim 11, wherein the UE dose not utilize GB resources when the UE intends to transmit using only one shared channel/RB set.

13. The UE of claim 10, wherein a utilization/selection of resources in GBs for sidelink transmission by the UE is based on UE's selected and/or reserved resource frequency position/location in an RB set adjacent to a GB.

14. The UE of claim 13, wherein a selection of a GB resource between two adjacent RB sets is based on a frequency position/location of a selected resource in a lower adjacent RB set or a higher adjacent RB set.

15. The UE of claim 13, wherein a first selection of a GB resource between two adjacent RB sets is based on a frequency position/location of a selected resource in a lower adjacent RB set or a higher adjacent RB set, and a second selection of a GB resource between two adjacent RB sets is based on the sidelink resource reservation information.

16. The UE of claim 14, wherein the selection of the GB resource based on the lower adjacent RB set or the higher adjacent RB set is pre-defined or configured to the UE.

17. The UE of claim 10, wherein in the GB resource selection based on the sidelink resource reservation information, a use of resource sensing results is used as a part of a mode 2 resource selection procedure to determine which GB resource is utilized by UEs that intend to transmit in multiple shared channels/RB sets.

18. The UE of claim 17, wherein when a certain resource within a shared channel/RB set is reserved by another UE but the another UE intends to transmit on a single shared channel/RB set, a resource in the GB that corresponds to or has the same resource index as the certain resource is selected for use by the UE that intends to transmit using multiple shared channels/RB sets.

19. A non-transitory machine-readable storage medium having stored thereon instructions that, when executed by a computer, cause the computer to perform a method of sidelink resource selection in a shared spectrum, the method comprising:
performing a guard band (GB) resource selection based on an allocated resource in an adjacent channel/resource block (RB) set and/or a sidelink resource reservation information.

20. The non-transitory machine-readable storage medium of claim 19, wherein a utilization/selection of resources in GBs for sidelink transmission is allowed for a user equipment (UE) transmitting sidelink signals/channels across multiple and consecutive shared channels/RB sets.
